(19) United States
(12) Patent Application Publication
(10) Pub. No.: US 2006/0071772 A1
(43) Pub. Date: Apr. 6, 2006

(54) System and method for test simulation

(76) Inventor: Stephen D. Janes, Fort Collins, CO (US)

Correspondence Address: AGILENT TECHNOLOGIES, INC.;Intellectual Property Administration, Legal Department, DL 429, P.O. Box 7599, Loveland, CO, 80537-0599, US

(21) Appl. No.: 10/956,696

(22) Filed: Oct. 1, 2004

(51) Int. Cl. G08B 29/00

(52) U.S. Cl. 340/515; 370/395.21

(57) ABSTRACT

A system and method to provide simulations of tests that execute in a communications network environment. The system and method include a test object and a simulator framework, coupled with an agent manager. The test object can initiate either live or simulated testing, or both. Live test characteristics, that result from the execution of the live test, can be used to create a test characteristics for the same test that is simulated by the simulator framework. The agent manager, coupled directly and/or through storage media to the simulator framework and the test object, can provide the results of live or simulated testing.

### BACKGROUND OF THE INVENTION

This invention relates generally to test simulation in a communications network environment.

Within a multimedia communications network, many products are required to enable various features that provide services to subscribers. To fully exercise these products, end-to-end testing is typically used, along with simulations of actual subscriber behavior. From the tests and simulations Quality of Service (QoS) and ultimately service level agreement (SLA) characterizations can be derived. In some test systems, network providers perform testing from the end user's point of view, using test scenarios that can include end-user simulation in a live network. A customer profile can be concentrated on a subscriber identification module (SIM) card, and many SIM cards can be required to fully emulate an end-to-end test system. Also, to accurately measure and evaluate the results of these tests and emulations, specialized probes can be required.

To complicate matters, general packet radio service (GPRS) and global system for mobile communication (GSM), which can enable multimedia messaging service (MMS), as well as e-mail, Hypertext Transfer Protocol, and File Transfer Protocol, can only accommodate limited resources for each user, and thus, using GPRS and/or GSM for one purpose can preclude simultaneous use for another. The regular tests that can be required for, for example, MMS, in order to monitor and maintain a high level of QoS must be managed such that they are part of a reasonable usage scenario within the limited capacity of GPRS and/or GSM.

Current simulation systems can provide random or scripted simulations of tests executing on communications networks. However, these simulation systems fall short for several reasons. Measurements that are either randomly generated, or are replayed through a scripting mechanism, may not reflect live network measurements, and may thus compromise training and/or sales opportunities, and may not accurately demonstrate capabilities such as threshold management. A scripting mechanism could address this, yet could also repeat itself at the end of the script, thus demonstrating a non-life-like repeating pattern.

What is needed is a way in which more meaningful and life-like measurements could be used in a simulation environment to control and demonstrate product value, yet still appear real. What is further needed is a system that can operate in large-scale environments, and in which scripts may be changed during run-time without a system restart. What is still further needed is a system that could enable product testing outside of the context of a live network, but under the simulated conditions of a live network.

### SUMMARY OF THE INVENTION

The problems set forth above as well as further and other problems are resolved by the present invention. The solutions and advantages of the present invention are achieved by the illustrative embodiments and methods described herein below.

The system and method of the present invention provide simulation scripting on a per execution interval/per measurement/per test basis, and configuration of pass/fail conditions, test duration times, and measurement values, all based on actual collected data within a live communications network. The system and method can also display captured live test trace and captured live test logging during simulation, compute computer-determined measurements, and perform simultaneous live and simulated test execution. Further, such a system could make use of measurements that are routinely made available by networking equipment in order to accurately simulate a live, non-static, network.

Operationally, the system and method of the present invention provide for taking measurements during a test over a live communications network. If the same test is chosen to simulate, test characteristics—such as measurements, duration, and status—from the live test, or derived by any other means, can be modified by a script, for example provided by the user, that is associated with the test. The test characteristics can be provided to a conventional agent manager that has the capability of coupling the test characteristics with a service model, which together can present to the user, for example, the results of simulating the test. If the test characteristics include captured live trace and log information, that information can also be presented to the user, for example, by the agent manager.

Test characteristics from a live test can be randomized within a range determined by the results from the live test, thus giving the simulation a non-repeating effect. In this case, lower and upper limits can be specified, and the random result can be guaranteed to fall within the specified range. Since each test, and each measurement within a test, under normal conditions, can have predictable results within a given range, ranges can be assigned to simulate real-life behavior.

The system and method of the present invention can overcome the static repeating mechanism of conventional simulation systems, thus making the simulation seem more life-like. In addition, large-scale environments can be accommodated, allowing customers to prototype new products within their existing operations without adversely affecting the behavior of the live communications network, nor adversely impacting product and service testing. Changes to the scripts (and therefore to the test characteristics) can be made dynamically during run-time operation, not requiring any process restarts. This allows customers to experiment with thresholding, SLA Management, etc., without having to restart the system.

In summary, the system and method of the present invention enhance existing test and simulation systems in, for example, but not limited to, the following ways:

(1) Enable emulation of a product without requiring the need for SIMs and probes;

(2) Enable sales/field/training personnel to demonstrate the emulated product more easily;

(3) Enable emulated product testing under controlled conditions;

(4) Enable scale testing on an underlying active test controller infrastructure; and

(5) Enable QoS and SLA characterization.

For a better understanding of the present invention, reference is made to the accompanying drawings and detailed description. The scope of the present invention is pointed out in the appended claims.

### DESCRIPTION OF THE SEVERAL VIEWS OF THE DRAWING

FIG. 1 is a schematic block diagram of the environment in which the system and method of the present invention can execute;

FIG. 2 is a schematic block diagram of the components of the test object and simulator framework of the illustrative embodiment of the present invention; and

FIG. 3 is a flowchart of the method of the illustrative embodiment of the present invention.

### DETAILED DESCRIPTION OF THE INVENTION

The present invention is now described more fully hereinafter with reference to the accompanying views of the drawing, in which the illustrative embodiments of the present invention are shown.

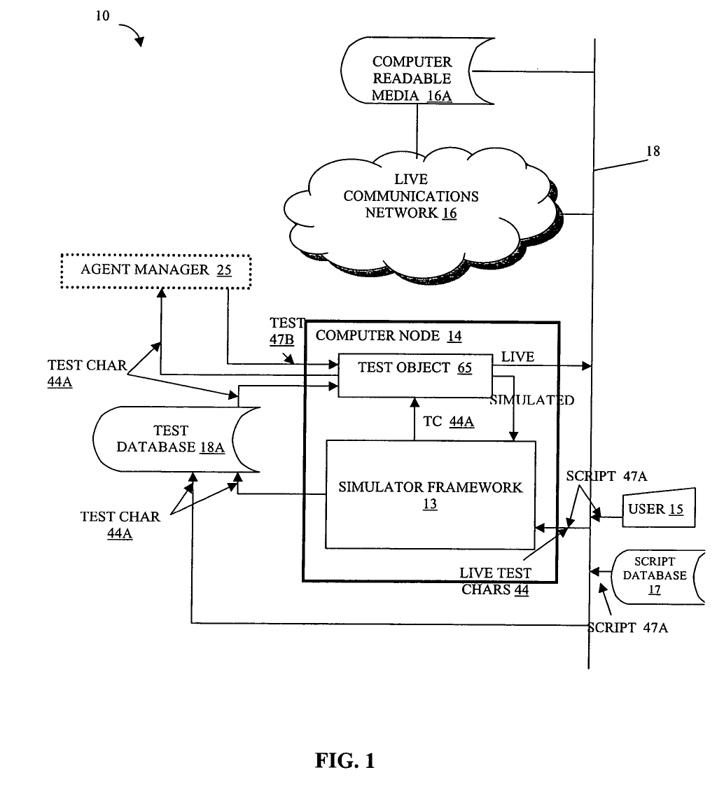

Referring now to FIG. 1, system 10 of the illustrative embodiment of the present invention can execute within computer node 14, which may have, but is not limited to, an electronic connection 18 to at least one live communications network 16. System 10 can include, but is not limited to, agent manager 25, test object 65, and simulator framework 13. Agent manager 25 is a conventional item, the details of which are not necessarily part of the present invention, having the capability of determining at least one test 47B and providing it to test object 65. Agent manager 25 can also receive at least one test characteristic 44A, couple it with a pre-specified service model, and present the results of simulating the at least one test 47B according to the received at least one test characteristic 44A. Test object 65 is a software artifact that can provide the structure for at least one test 47B. For example, the actions test 47B can take and the variable values that describe it, according to conventional object-oriented paradigms. Test object 65 can determine if at least one test 47B is to be executed live or simulated, and can submit at least one test 47B for live execution, for example, to at least one live communications network 16. Test object 65 can also invoke simulator framework 13 to simulate at least one test 47B. The architecture of the present invention can accommodate multiple test objects 65 that can simultaneously initiate live and simulated execution of at least one test 47B. At least one live test characteristic 44 can be provided to simulator framework 13 as a result of the execution of at least one test 47B.

Continuing to refer to FIG. 1, simulator framework 13 can receive at least one script 47A from, for example, a user 15, a script database 17, at least one live communications network 16, or any other means. In other variations, user 15 can enter at least one script 47A to be stored directly to script database 17, or at least one live communications network 16 can automatically create at least one script 47A during or after the execution of at least one test 47B. Simulator framework 13 can bind at least one test 47B to at least one script 47A, and can determine at least one test characteristic 44A based on at least one script 47A and at least one live test characteristic 44. Alternatively, simulation framework 13 can determine at least test characteristic 44A independent of at least one script 47A and at least one live test characteristic 44. Simulator framework 13 can provide at least one test characteristic 44A to agent manager 25—directly, through test object 65, indirectly through test database 18A, or by any other means.

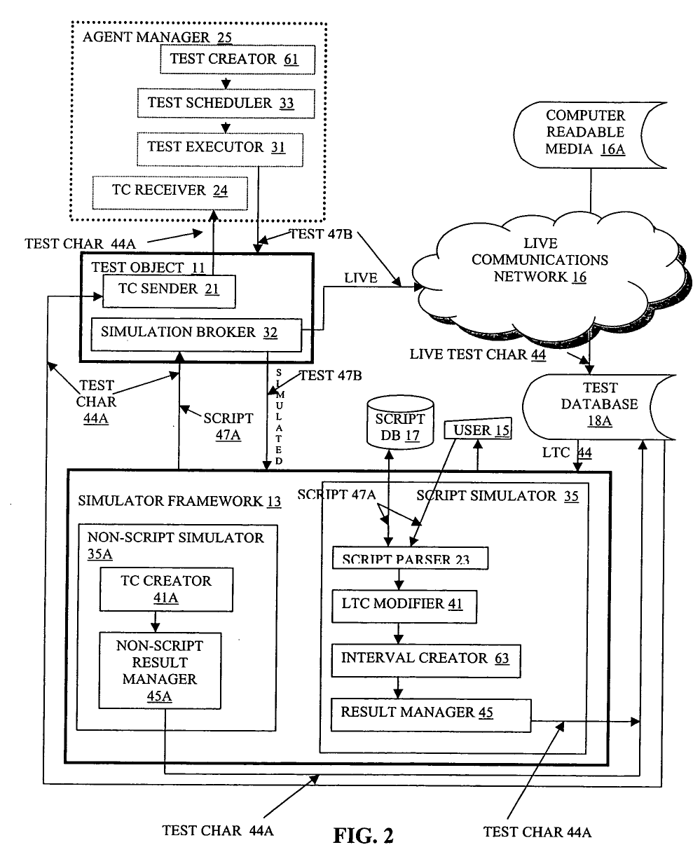

Referring now to FIG. 2, agent manager 25 can provide the following functionality in order to integrate with system 10: test creation (accomplished illustratively by test creator 61), test scheduling (accomplished illustratively by test scheduler 33), test execution (accomplished illustratively by test executor 31), and live test characteristics reception (accomplished illustratively by test characteristics (TC) receiver 24). This functionality can be provided in any form and is not limited to a particular organization or functional breakdown. In addition, agent manager 25 can provide the results of simulating at least one test 47B according to at least one test characteristic 44A provided by simulation framework 13 through test object 65.

Continuing to refer to FIG. 2, test object 65 can include, but is not limited to TC sender 21 and simulation broker 32. TC sender 21 can route at least one test characteristic 44A from simulator framework 13 to agent manager 25 after at least one test 47B completes simulation. Simulation broker 32 can determine if at least one test 47B is to be executed live or simulated and can submit at least one test 47B for execution to at least one live communications network 16. At least one test characteristic 44A can include, but is not limited to, at least one status that can specify at least one outcome for at least one test 47B, at least one duration that can specify the execution time required for at least one test 47B, and at least one measurement that can specify at least one expected observation resulting from the execution of at least one test 47B. Optionally, at least one test characteristic 44A can include at least one captured live trace and at least one captured live log.

Continuing to refer to FIG. 2, simulator framework 13 can include, but is not limited to, script simulator 35 and non-script simulator 35A. Script Simulator 35 can receive at least one script 47A, and can create at least one test characteristic 44A based on at least one live test characteristic 44 and at least one script 47A. Script simulator 35 can provide at least one test characteristic 44A to agent manager 25. Non-script simulator 35A can determine at least one test characteristic 44A associated with at least one test (47B) and can provide at least one test characteristic 44A to said agent manager (25).

Continuing to further refer to FIG. 2, script simulator 35 can also include script parser 23 which can receive script information from user 15, script database 17, and/or at least one live communications network 16, or any variation as described above, and create at least one script 47A. Script simulator 35 can also include live test characterization (LTC) modifier 41 which can create at least one test characteristic 44A according to at least one script 47A and at least one live test characteristic 44. Script simulator 35 can also include interval creator 63 which can create one or more intervals based on at least one script 47A. Script simulator 35 can further include result manager 45 which can determine which interval is currently scheduled, and can associate at least one test characteristic 44A with the interval, all of which can be stored in test database 18A for access by test object 65 to provide to agent manager 25. In script simulation, at least one script 47A can be modified during the interval in which at least one test 47B is being executed, so as to allow variation in the simulation without having to restart the process.

Continuing to still further refer to FIG. 2, non-script simulator 35A can include, but is not limited to, TC creator 41A and non-script result manager 45A. TC creator 41A can determine, based on any computational strategy, at least one test characteristic 44A. For example, TC creator 41A can create at least one test characteristic 44A based on random numbers. Non-script result manager 45A can provide at least one test characteristic 44A to agent manager 25.

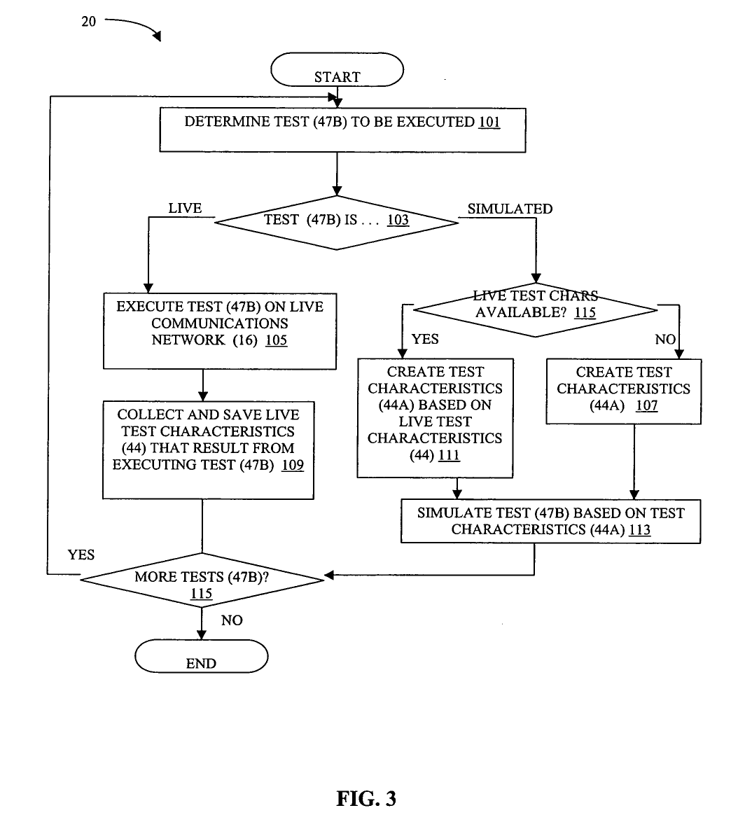

Referring now primarily to FIG. 3, method 20 of the present invention can include, but is not limited to, the step of determining at least one test 47B to be executed (method step 101). If at least one test 47B is to be executed live (decision step 103), the method can include the steps of executing at least one test 47B within at least one live communications network 16 (method step 105), and collecting and saving at least one live test characteristic 44 that result from method step 105 (method step 109). If there are more tests to run (decision step 115), method 20 can further include the step of repeating method steps 101, 103, 105, 109. If at least one test 47B is to be simulated (decision step 103), and if at least one live test characteristic 44 is available, method 20 can include the steps of creating at least one test characteristic 44A based on at least one live test characteristic 44 (method step 111) and simulating at least one test 47B based on the at least one test characteristic 44A (method step 113). If at least one test 47B is to be simulated (decision step 103), and if at least one live test characteristic 44 is not available, method 20 can include the steps of creating at least one test characteristic 44A (method step 107) and simulating at least one test 47B based on the at least one test characteristic 44A (method step 113). Method 20 can further include the step of repeating method steps 101-113 if there are more tests to execute.

Method 20 (FIG. 3) can be, in whole or in part, implemented electronically. Signals representing actions taken by elements of system 10 (FIG. 1) can travel over at least one live communications network 16 (FIG. 1). Control and data information can be electronically executed and stored on at least one computer-readable medium 16A (FIG. 1). The system can be implemented to execute on at least one computer node 14 (FIG. 1) in at least one live communications network 16. Common forms of at least one computer-readable medium 16A can include, for example, but not limited to, a floppy disk, a flexible disk, a hard disk, magnetic tape, or any other magnetic medium, a CDROM or any other optical medium, punched cards, paper tape, or any other physical medium with patterns of holes, a RAM, a PROM, and EPROM, a FLASH-EPROM, or any other memory chip or cartridge, a carrier wave, or any other medium from which a computer can read.

Referring again primarily to FIG. 1, an operational use of the illustrative embodiment of the present invention can involve a table that can be created to embody the coordination of at least one test characteristic 44A with at least one test 47B, perhaps based on at least one live test characteristic 44 and at least one script 47A, perhaps grouped in execution intervals. Microsoft Excel can be used to create such a table, an example of which follows:

| A | | B | C | D | E | F | G | H | I | J | K | L | M | N |
|---|---|---|---|---|---|---|---|---|---|---|---|---|---|---|
| | | Dura- | | | | | | | | | | | | |
| 1 | Interval | tion | Status | TcID | CallID | a_value | b_value | c_value | d_value | e_value | f_value | Trace | Details | Desc |

| | | | | | | | | | | | | |
|---|---|---|---|---|---|---|---|---|---|---|---|---|
| 2 | 1 | 5 | PASS | 1 | 1 | 15:18 | 40:45 | 100 | 100 | 100 | SmsMoMt [symbol] | SmsMoMt_testrun.run |
| 3 | 2 | 10 | FAIL | 1 | 1 | 18:22 | 55:65 | 0 | 0 | 0 | SmsMoMt [symbol] | SmsMoMt_testrun.run |
| 4 | 3 | 15 | INCONC | 1 | 1 | 15:25 | 37:42 | | | | SmsMoMt [symbol] | SmsMoMt_testrun.run |
| 5 | 4 | 20 | PASS | 1 | 1 | 20:25 | 43:48 | 100 | 100 | 100 | SmsMoMt [symbol] | SmsMoMt_testrun.run |

In the example, the first line can include column headers and each subsequent line can define execution interval behavior. The first column labeled ‘Interval’ can identify the execution interval that can contain at least one test 47B in an order chosen, for example, by user 15. The second column labeled ‘Duration’ can identify at least one duration which is defined in this example to be the length of time for which at least one test 47B can be run within its execution interval. At least one duration could be used to simulate stress testing or simply to add realism to the simulation. At least one duration can be optional. In this case, at least one test can execute for a time equal to the frequency at which at least one live test characteristic 44 was collected. The third column labeled ‘Status’ can identify at least one status which is defined in this example to be the resulting condition for at least one test 47B. Three possible values for at least one status are “PASS”, “FAIL”, and “INCONC”.

Continuing to refer to FIG. 1 and the table above, the fourth and fifth columns labeled ‘TcID’ and ‘CallID’ can identify at least one test 47B and a ‘call ID’ respectively. In this example, these values are used in conjunction with the ‘a_value’-‘f_value’ properties, and can be used as primary keys for database retrieval into, for example, test database 18A. The columns labeled ‘a_value’-‘f_value’ columns can identify at least one measurement and any other at least one test characteristic 44A value. The columns labeled ‘Trace’ and ‘Details’ can refer to filenames that are related to the execution interval that contains at least one test 47B. During simulation, the table in this example can be viewed. The column labeled ‘Desc’ can be optionally used for fields not related to the example or this invention. After the table is created, it could be saved, for example in test database 18A.

Although the invention has been described with respect to various embodiments and methods, it should be realized that this invention is also capable of a wide variety of further and other embodiments and methods within the spirit and scope of the appended claims.

What is claimed is:

1. A system for simulating at least one test comprising:
an agent manager capable of determining at least one test;
a test object coupled with said agent manager, said test object capable of submitting said at least one test for live execution, said test object capable of capturing at least one live test characteristic from the execution of said at least one test; and
a simulator framework coupled to said test object, said simulator framework capable of determining at least one test characteristic based on said at least one live test characteristic associated with said at least one test, said simulator framework capable of simulating said at least one test, said simulator framework capable of providing said at least one test characteristic to said agent manager.

2. The system as defined in claim 1 wherein said simulator framework is capable of receiving at least one script from a user, said at least one script being used in conjunction with said at least one live test characteristic to create said at least one test characteristic.

3. The system as defined in claim 2 wherein said simulator framework is capable of receiving said at least one script from a script database, said at least one script being used in conjunction with said at least one live test characteristic to create said at least one test characteristic.

4. The system as defined in claim 2 wherein said simulator framework is capable of receiving said at least one script from at least one live communications network, said at least one script being used in conjunction with said at least one live test characteristic to create said at least one test characteristic.

5. The system as defined in claim 1 wherein said simulator framework is capable of providing said at least one test characteristic to a test database.

6. The system as defined in claim 1 wherein said at least one live test characteristic includes at least one captured live trace.

7. The system as defined in claim 1 wherein said at least one live test characteristic includes at least one captured live log.

8. The system as defined in claim 1 further comprising a plurality of said test objects, wherein said plurality of said test objects are capable of simultaneous initiation of live and simulated execution of said at least one test.

9. The system as defined in claim 1 wherein said test object comprises:
a test characteristic sender capable of routing said at least one test characteristic from said simulator framework to said agent manager; and
a simulation broker capable of determining if said at least one test is to be executed live or simulated, said simulation broker capable of submitting said at least one test for execution to said at least one live communications network, said simulation broker capable of invoking said simulator framework to create said at least one test characteristic.

10. The system as defined in claim 1 wherein said at least one test characteristic comprises:
at least one status capable of specifying at least one outcome for said at least one test;
at least one duration capable of specifying the execution time required for said at least one test; and
at least one measurement capable of specifying at least one expected observation resulting from the execution of said at least one test.

11. The system as defined in claim 1 wherein said simulator framework comprises:
a script simulator capable of receiving said at least one script, said script simulator capable of creating said at least one test characteristic based on said at least one live test characteristic and said at least one script, said script simulator capable of providing said at least one test characteristic to said agent manager; and
a non-script simulator capable of determining said at least one test characteristic associated with said at least one test, said at least one test characteristic based on random values, said non-script simulator capable of providing said at least one test characteristic to said agent manager.

12. A method for simulating at least one test comprising the steps of:
determining at least one test to be executed;
executing the at least one test within at least one live communications network;
collecting and saving at least one live test characteristic that results from said step of executing the at least one test;
creating at least one test characteristic based on the at least one live test characteristic associated with the at least one test; and
simulating the at least one test based on the at least one test characteristic.

13. The method as defined in claim 13 further comprising the step of:
including captured live trace and captured live log in the at least one test characteristic.

14. At least one computer node for carrying out the method according to claim 12.

15. At least one live communications network comprising at least one computer node according to the method of claim 12.

16. A computer data signal embodied in electromagnetic signals traveling over at least one live communications network carrying information capable of causing at least one computer node in said at least one live communications network to practice the method of claim 12.

17. At least one computer readable medium having instructions embodied therein for the practice of the method of claim 12.

18. A system for simulating at least one test comprising the steps of:
means for determining at least one test to be executed;
means for executing said at least one test within at least one live communications network;
means for collecting and saving at least one live test characteristic from said means for executing said at least one test;
means for creating at least one test characteristic based on said at least one live test characteristic associated with said at least one test; and
means for simulating said, at least one test based on said at least one test characteristic.

19. A method for simulating at least one test comprising the steps of:
determining at least one test;
submitting the at least one test for live execution;
capturing at least one live test characteristic from the execution of the at least one test;
determining at least one test characteristic based on the at least one live test characteristic associated with the at least one test; and
simulating the at least one test.
